(19) United States
(12) Patent Application Publication
(10) Pub. No.: US 2023/0312843 A1
(43) Pub. Date: Oct. 5, 2023

(54) PROCESS FOR PREPARATION OF A NUCLEATED POLYPROPYLENE MASTERBATCH USING DIUREA COMPOUNDS

(71) Applicant: HINDUSTAN PETROLEUM CORPORATION LIMITED, Bangalore (IN)

(72) Inventors: Srinivas Rao PADADA, Hoskote Taluk (IN); Pravin Gopal KADAM, Hoskote Taluk (IN); Bennet CHELLIAHN, Hoskote Taluk (IN); Ramachandrarao BOJJA, Hoskote Taluk (IN)

(21) Appl. No.: 18/180,490

(22) Filed: Mar. 8, 2023

(30) Foreign Application Priority Data
Mar. 30, 2022 (IN) 202241019000

(51) Int. Cl. C08J 3/22; C08K 5/21

(52) U.S. Cl. CPC C08J 3/22; C08K 5/21; C08J 2323/12

(57) ABSTRACT

The invention relates to a polypropylene based nucleating agent masterbatch and a preparation method thereof. The masterbatch is composed of, by weight, 2 to 60 wt. % of diurea based nucleating agent, 40 to 98 wt. % parts of polypropylene resin. The present invention discloses a process for preparation of a polypropylene masterbatch by mixing polypropylene with a nucleating agent as represented in FIG. 2. According to the invention, the prepared polypropylene masterbatch has the advantages of being a masterbatch which can be added in any grade of polypropylene, does not cause inhalation hazards while handling, is easy to handle and has improved dispersion in the base polypropylene.

### FIELD OF THE INVENTION

The present invention discloses a process for preparation of a nucleated polypropylene masterbatch. More particularly, the present invention discloses a process for preparation of a polypropylene masterbatch by melt-mixing polypropylene with diurea as a nucleating agent.

### BACKGROUND OF THE INVENTION

Nucleating agents are a set of additives added during the polymer manufacturing as it enhances the mechanical properties and transparency of the finished polymer; also providing faster crystallization rates. Nucleating agents are currently much more in demand than ever before. Offering a heterogeneous surface to the monomer mix, the nucleating agents help in initiating crystallization and augments the rate of production. Sufficient amount of nucleating agents allows to maintain consistent size of spherulites. Market of the nucleating agents is highly dependent upon the plastics and polymer manufacturing industry. As it is largely employed in enhancing the strength, reducing the cycle time by increasing the rate of crystallization and improving the clarification of plastics and other polymers. Nucleating agents are anticipated to grow in tandem with the plastics and polymer manufacturing industry. Growth in the packaging industry is considered as a key factor driving the global nucleating agents market for plastics and polymers.

US20110218279A1 relates to a polypropylene-based resin composition containing a specific crystal nucleating agent.

US20030236332A1 discloses a method of nucleating a thermoplastic formulation comprising the steps of a) providing a molten thermoplastic formulation; b) introducing, either simultaneously or separately, at least one compound substantially soluble within said formulation of step “a” selected from the group consisting of at least one bicyclic compound and at least one monocycloaliphatic compound, and at least one organic salt; and c) allowing the resultant mixture in step “b” to cool to form a nucleated thermoplastic article; wherein said nucleated thermoplastic article exhibits a peak crystallization temperature in excess of that for the same thermoplastic free from any nucleation agent therein.

EP3049469B1 relates to nucleating agents for thermoplastic polymers, thermoplastic polymer compositions comprising such nucleating agents, articles made from such thermoplastic polymer compositions, and methods for making and molding such thermoplastic polymer compositions.

U.S. Pat. No. 6,235,823B1 discloses a crystalline polypropylene resin composition comprising a crystalline polypropylene resin and a β-nucleating agent, and a method of increasing the proportion of β-form crystals in a crystalline polypropylene resin molding comprising molding the composition, the β-nucleating agent being a diamide compound.

What is needed, therefore, is to provide a polypropylene nucleating agent masterbatch, using diurea compounds as nucleating agent, composition which can be added in any grade of polypropylene to obtain the required concentrations.

### OBJECTIVES OF THE INVENTION

It is a primary objective of the invention to prepare a masterbatch of polypropylene (PP).

A further objective of the present invention is to produce a masterbatch of polypropylene (PP) using nucleating agent.

Another objective of the present invention is to produce a masterbatch of polypropylene (PP) using MDI-Aniline/IPDI-Aniline/HMDI-Aniline (diurea compounds) as nucleating agents.

### SUMMARY OF THE INVENTION

In an aspect of the present invention, the present invention discloses a process for preparing a nucleating agent masterbatch by melt mixing a polypropylene having a melt flow index ranging in between 1.5 to 40 g/10 min with nucleating agent having wt. % in a range of 2 to 60 wt. %; wherein the nucleating agent is a reaction product of at least one isocyanate and at least one amine, and wherein the wt. % is based on the total weight of the masterbatch.

In an embodiment of the present invention, the isocyanate is selected from a group consisting of aliphatic, cycloaliphatic, aryl aliphatic, and aromatic isocyanates.

In an embodiment of the present invention, the diisocyanates used are Methylene diphenyl diisocyanate (MDI), Isophorone diisocyanate (IPDI), and Hexamethylene diisocyanate (HMDI).

In an embodiment of the present invention, the amine is an aromatic amine, and the aromatic amine is selected from a group consisting of aniline, p-aminotoluene, o-aminotoluene, 2,4-diaminotoluene, 2,6-diaminotoluene, p-phenylaniline, α-aminonaphthylene, 4,4′-diaminobiphenyl, p-phenylenediamine, and 4,4′-methylenebisaniline. The aliphatic amines methyl amine, ethyl amine and like, cycloaliphatic amines includes hexyl amine and like, can also be used.

In an embodiment of the present invention, the aromatic amine is aniline.

In an embodiment of the present invention, the amine is an aliphatic amine, and the aliphatic amine is selected from a group comprising of methyl amine, ethyl amine and the like.

In an embodiment of the present invention, the amine is a cycloaliphatic amine, and the cycloaliphatic amine is hexyl amine and the like.

In an embodiment of the present invention, the melt mixing is carried out at a temperature ranging between 150-300° C.

In an embodiment of the present invention, reaction of MDI-Ani/IPDI-Ani/HMDI-Ani, was performed as per the methodology of Mokeev et al. [Mokeev, M. V., Ostanin, S. A. and Zuev, V. V., 2020. Hydrogen bonding in dicyclohexylmethane—or diphenylmethane based urea compounds and their polymer counterparts investigated by NMR spectroscopy: Interplay of electronic and geometrical factors. Chemical Physics Letters, 739, p. 137047.]

In another aspect of the present invention, discloses a nucleated polypropylene having the nucleating agent masterbatch obtained by the process as disclosed above.

In one another aspect of the present invention, discloses a process for preparing a nucleated polypropylene by melt mixing the polypropylene having a melt flow index ranging in between 1.5 g/10 min to 40 g/10 min with the nucleating agent masterbatch obtained by the process as disclosed above.

In an embodiment of the present invention, the polypropylene is polypropylene homopolymer, and/or polypropylene copolymer with any other alkene or acrylate or halo-alkenes.

In an embodiment of the present invention, the concentration of nucleating agents further diluted to 250-20000 ppm in polypropylene to make nucleated polypropylene.

In an embodiment of the present invention, the melt mixing for preparing the master batch with polypropylene and nucleating agent is carried out in batch mixer, micro-compounder, single screw extruder, two roll mill or any other processing equipment.

In an embodiment of the present invention, crystallization temperature is increased from 116° C. to 129° C. by incorporation of 250 to 1000 ppm.

### BRIEF DESCRIPTION OF THE DRAWINGS

FIG. 1: Polarized optical microscopic images obtained for the prepared examples. A: iPP, B: Example 3, C: Comparative Example 1, D: Example 6, E: Comparative Example 2, F: Example 9, G: Comparative Example 3

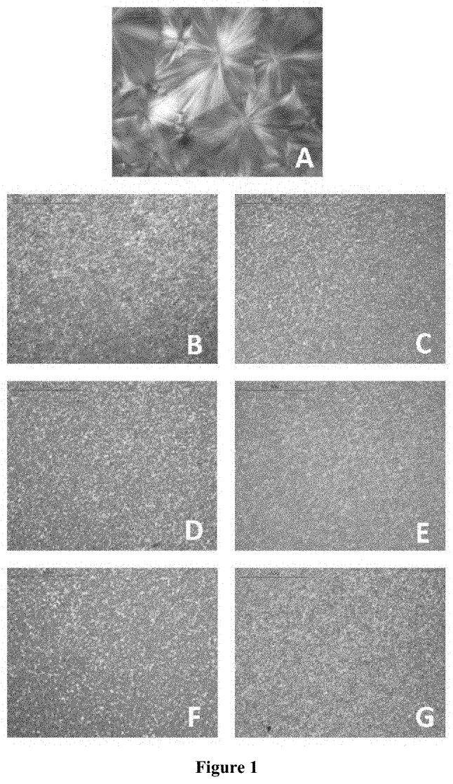

FIG. 2. Schematic for preparation of a polypropylene masterbatch by mixing polypropylene with a nucleating agent.

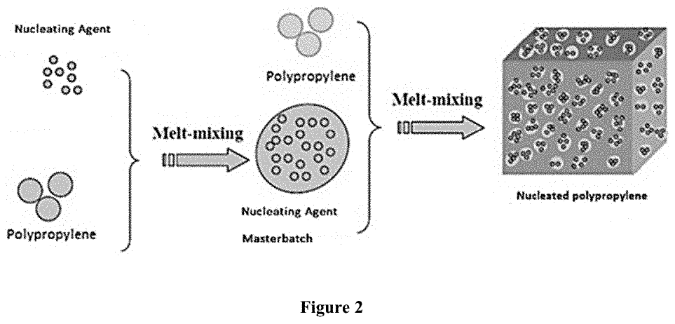

### DETAILED DESCRIPTION OF THE INVENTION

In an aspect of the present invention, discloses a process for preparing a nucleating agent masterbatch, comprising: a) polypropylene having a melt flow index ranging in between 1.5 to 40 g/10 min; and b) mixing the melted polypropylene with a nucleating agent having wt. % in a range of 2 to 60 wt. %; wherein the nucleating agent is a reaction product of at least one isocyanate and at least one amine, and wherein the wt. % is based on the total weight of the polypropylene.

In a feature of the present invention, the isocyanate is selected from a group consisting of aliphatic, cycloaliphatic, aryl aliphatic, and aromatic isocyanates.

In an embodiment of the present invention, the diisocyanates used are Methylene diphenyl diisocyanate (MDI), Isophorone diisocyanate (IPDI), and Hexamethylene diisocyanate (HMDI).

In a feature of the present invention, the amine is an aromatic amine, and the aromatic amine is selected from a group consisting of aniline, p-aminotoluene, o-aminotoluene, 2,4-diaminotoluene, 2,6-diaminotoluene, p-phenylaniline, α-aminonaphthylene, 4,4′-diaminobiphenyl, p-phenylenediamine, and 4,4′-methylenebisaniline. The aliphatic amines methyl amine, ethyl amine and like, cycloaliphatic amines include hexyl amine and like, can also be used.

In a feature of the present invention, the aromatic amine is aniline.

In a feature of the present invention, the amine is an aliphatic amine, and the aliphatic amine is selected from a group comprising of methyl amine, ethyl amine and the like.

In a feature of the present invention, the amine is a cycloaliphatic amine, and the cycloaliphatic amine is hexyl amine and the like.

In a feature of the present invention, the isocyanates are selected from aliphatic, cycloaliphatic, aryl aliphatic, and/or aromatic isocyanates, preferably diisocyanates, for example tri-, tetra-, penta-, hexa-, hepta-and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate, and/or dicyclohexylmethane 4,4′-, 2,4′- and 2,2′-diisocyanate, diphenylmethane 2,2′-, 2,4′- and/or 4,4′-diisocyanate (MDI), naphthylene 1,5-diisocyanate (NDI), tolylene 2,4- and/or 2,6-diisocyanate (TDI), diphenylmethane diisocyanate, 3,3′-dimethylbiphenyl diisocyanate, 1,2-diphenylethane diisocyanate, and/or phenylene diisocyanate.

In a feature of the present invention, reaction of MDI-Ani/IPDI-Ani/HMDI-Ani, was performed as per the methodology of Mokeev et al. [Mokeev, M. V., Ostanin, S. A. and Zuev, V. V., 2020. Hydrogen bonding in dicyclohexylmethane—or diphenylmethane based urea compounds and their polymer counterparts investigated by NMR spectroscopy: Interplay of electronic and geometrical factors. Chemical Physics Letters, 739, p. 137047.]

In a feature of the present invention, the melt mixing is carried out at a temperature ranging between 150-300° C.

In another aspect of the present invention, discloses a nucleated polypropylene having the nucleating agent masterbatch obtained by the process as disclosed above.

In another aspect of the present invention, discloses a process for preparing a nucleated polypropylene by melt mixing polypropylene having a melt flow index ranging in between 1.5 g/10 min to 40 g/10 min with the nucleating agent masterbatch obtained by the process as disclosed above.

In another aspect of the present invention, discloses a process for preparing a nucleating agent masterbatch by melt mixing a polypropylene having a melt flow index ranging in between 1.5 g/10 min to 40 g/10 min and 2 wt. % to 60 wt. % of the nucleating agent, wherein the nucleating agent is a reaction product of at least one isocyanate and at least one amine, and wherein the wt. % is based on the total weight of the masterbatch; wherein, the isocyanate is selected from a group consisting of aliphatic, cycloaliphatic, aryl aliphatic, and aromatic isocyanates; wherein, the diisocyanates used are Methylene diphenyl diisocyanate (MDI), Isophorone diisocyanate (IPDI), and Hexamethylene diisocyanate (HMDI); and the amine is an aromatic amine, and the aromatic amine is selected from a group consisting of aniline.

In one another aspect of the present invention, discloses a process for preparing a nucleating agent masterbatch by melt mixing a polypropylene having a melt flow index ranging in between 1.5 g/10 min to 40 g/10 min and 2 wt. % to 60 wt. % of a nucleating agent, wherein the nucleating agent is a reaction product of at least one isocyanate and at least one amine, and wherein the wt. % is based on the total weight of the masterbatch; wherein, the isocyanate is selected from a group consisting of aliphatic, cycloaliphatic, aryl aliphatic, and aromatic isocyanates; the diisocyanates used are Methylene diphenyl diisocyanate (MDI), Isophorone diisocyanate (IPDI), and Hexamethylene diisocyanate (HMDI); and the amine is an aromatic amine, and the aromatic amine is selected from a group consisting of aniline; wherein the melt mixing is carried out at a temperature ranging between 150-300° C.

Nucleating agent is added in polypropylene (PP) to prepare a masterbatch. The advantages of said masterbatch are:
Prepared masterbatch can be added in any grade of polypropylene
No inhalation while handling
Easy to handle
Better dispersion in PP while dilution requisite concentration

Materials used: Polypropylene homopolymer (iPP) having MFI of 12.5 g/10 min, and density of 0.9 g/cm³. Methylene diphenyl diisocyanate (MDI), Isophorone diisocyanate (IPDI), Hexamethylene diisocyanate (HMDI), Aniline, Toluene, and Methanol were purchased from Sigma Aldrich. All chemicals were used as obtained without any further modification or purification.

Polymer Processing: Masterbatch preparation methodology: Extrusion of iPP and the prepared formulations was performed on a co-rotating twin-screw extruder (M/s. Boolani Engineering Corporation, Mumbai, India) having screw diameter of 30 mm, L/D of 48/1 and equipped with eight heating zones. Initially, PP was premixed with nucleating agent in a high-speed mixer for 5 to 20 min and then fed into the extruder through the hopper. Temperature profile in extruder was maintained as from 160 to 230° C. from feed zone to the die zone. Feeder screw and extruder screw speeds were set at 10 and 225 rpm, respectively. The extrudate was cooled by passing it through a water bath (maintained at 25° C. with continuous water circulation) and pelletized subsequently. Obtained pellets were dried in oven at 105° C. for about 2-3 hours prior to injection molding. Above mentioned masterbatch can also be prepared using batch mixer, micro-compounder, single screw extruder, two roll mill or any other processing equipment.

Nucleating agent masterbatch can be prepared with nucleating agent concentration ranging from 2 wt. % to 60 wt. %; whereas, to prepare nucleated polypropylene the prepared masterbatch can be diluted from 250 to 20000 ppm concentration. In the current disclosure concentration of the nucleating agent in the masterbatch was maintained at 10 wt. %.

Dilution of masterbatch and sample preparation: Dilution of masterbatch to prepare 250 to 1000 ppm nucleated polypropylene was performed using similar processing conditions as mentioned for the extrusion process under masterbatch preparation methodology.

Injection molding (M/s. Aurburg All Rounder 410C, Germany) was performed by maintaining the temperature profile from 190 to 230° C. from the hopper to the ejection nozzle. Injection pressure, packing pressure and cooling time were maintained constant at 240 bar, 1000 bar, and 20 s, respectively, throughout the molding process.

Testing and Characterization: Melt Flow Index (MFI) was determined as per ASTM D1238. Tensile properties [tensile strength (TS), percentage elongation at yield (E@Y)] and flexural properties [flexural modulus (FM)] were measured according to ASTM D638 and D790, respectively. Notched izod impact (IM) test was performed as per ASTM D256. Shore D hardness (SD) was determined in accordance with ASTM D2240. Differential scanning calorimetry (DSC) test was performed as per ASTM D3418. Percentage crystallinity was determined using DSC as per the method provided by Brzozowska-Stanuch et al. (Brzozowska-Stanuch, A., Rabiej, S., Fabia, J. and Nowak, J., 2014. Changes in thermal properties of isotactic polypropylene with different additives during aging process. Polimery, 59 (4), pp. 302-307.) Shrinkage ratio (SR) of the prepared nucleated and also that of un-nucleated samples were determined in accordance with ASM D955. Heat Deflection Temperature (HDT) and VICAT Softening Temperature (VSP) of the prepared compositions was determined as per ASTM D648 (Method A) and D1525 (Method A), respectively.

The spherulite morphology of the prepared polypropylene compositions was studied on thin films about 0.1 mm by a Leica DMLP (M/s. Linkam Scientific Instruments, Britain) Polarized optical microscope with an automatic hot stage thermal control. A sample was sandwiched between two microscope cover glasses, melted at 230° C. for 5 min to eliminate thermal history, and then cooled to room temperature at a rate of 10° C./min.

Table 1 details the compositions prepared in Examples 1 to 9 and Comparative Examples 1 to 3. Obtained properties for the prepared examples is listed in Tables 2-4.

TABLE 1
Prepared compositions: Examples 1 to
9 and Comparative Examples 1 to 3

| | | Masterbatch | |
|---|---|---|---|
| | | Concentration | NA Conc. |
| Examples | iPP (g) | (g, phr) | (ppm) |
| iPP | 1000 | 0.0, 0.00 | 0.00 |
| Example 1 | 1000 | 2.5, 0.25 | 250 |
| Example 2 | 1000 | 5.0, 0.50 | 500 |
| Example 3 | 1000 | 10.0, 1.0 | 1000 |
| Comparative Example 1 | 1000 | — | 1000¹ |
| Example 4 | 1000 | 2.5, 0.25 | 250 |
| Example 5 | 1000 | 5.0, 0.50 | 500 |
| Example 6 | 1000 | 10.0, 1.0 | 1000 |
| Comparative Example 2 | 1000 | — | 1000² |
| Example 7 | 1000 | 2.5, 0.25 | 250 |
| Example 8 | 1000 | 5.0, 0.50 | 500 |
| Example 9 | 1000 | 10.0, 1.0 | 1000 |
| Comparative Example 3 | 1000 | — | 1000³ |

NA Conc.: Final concentration of the nucleating agent in polypropylene on addition of MDI-MB/IPDI-MB/HMDI-MB/MDI-Ani, IPDI-Ani, HMDI-Ani
¹Direct addition of 1000 ppm of nucleating agent (MDI-Ani) in iPP
²Direct addition of 1000 ppm of nucleating agent (IPDI-Ani) in iPP
³Direct addition of 1000 ppm of nucleating agent (HMDI-Ani) in iPP

TABLE 2
Mechanical properties obtained for Examples
1 to 9 and Comparative Examples 1 to 3

| Examples | TS (MPa) | E@Y (%) | FM (MPa) | IM (J/m) | SD |
|---|---|---|---|---|---|
| iPP | 34.6 | 15.2 | 1480 | 26.4 | 68.0 |
| Example 1 | 35.0 | 15.6 | 1600 | 29.4 | 69.9 |
| Example 2 | 35.9 | 14.0 | 1700 | 28.4 | 69.6 |
| Example 3 | 37.1 | 13.5 | 1720 | 28.3 | 70.1 |
| Comparative | 36.5 | 13.8 | 1650 | 28.4 | 70.3 |
| Example 1 | | | | | |
| Example 4 | 35.8 | 17.1 | 1330 | NA | 71.0 |
| Example 5 | 35.1 | 17.5 | 1310 | NA | 71.3 |
| Example 6 | 34.7 | 17.9 | 1300 | NA | 71.5 |
| Comparative | 35.9 | 17.4 | 1390 | NA | 71.7 |
| Example 2 | | | | | |
| Example 7 | 35.3 | 17.2 | 1290 | NA | 70.0 |
| Example 8 | 35.0 | 17.9 | 1300 | NA | 70.5 |
| Example 9 | 34.8 | 18.2 | 1330 | NA | 69.9 |
| Comparative | 35.3 | 17.9 | 1310 | NA | 69.8 |
| Example 3 | | | | | |

TABLE 3
DSC analysis data obtained for Examples
1 to 9 and Comparative Examples 1 to 3

| | Tm | Hm | Tc | Hc | % |
|---|---|---|---|---|---|
| Examples | (° C.) | (J/g) | (° C.) | (J/g) | Crystallinity |
| iPP | 164.7 | 101.2 | 115.8 | 99.1 | 47.9 |
| Example 1 | 166.3 | 103.5 | 121.8 | 102.9 | 49.7 |
| Example 2 | 165.9 | 99.9 | 125.6 | 98.5 | 47.6 |
| Example 3 | 166.3 | 106.1 | 128.8 | 104.6 | 50.5 |
| Comparative | 166.9 | 105.7 | 128.1 | 103.4 | 50.0 |
| Example 1 | | | | | |
| Example 4 | 166.5 | 61.7 | 125.98 | 69.8 | 33.7 |
| Example 5 | 166.4 | 90.7 | 117.06 | 100.4 | 48.5 |
| Example 6 | 164.2 | 87.2 | 117.07 | 97.9 | 47.3 |
| Comparative | 165.9 | 114.2 | 119.1 | 107.3 | 51.8 |
| Example 2 | | | | | |
| Example 7 | 166.2 | 82.8 | 116.6 | 91.1 | 44.0 |
| Example 8 | 167.0 | 86.7 | 116.1 | 102.2 | 49.4 |
| Example 9 | 165.8 | 89.3 | 116.7 | 95.8 | 46.3 |
| Comparative | 166.7 | 94.7 | 118.8 | 101.1 | 48.8 |
| Example 3 | | | | | |

TABLE 4
Thermal properties obtained for Examples
1 to 9 and Comparative Examples 1 to 3

| Examples | MFI (g/10 min) | SR (%) |
|---|---|---|
| iPP | 12.1 | 1.00 |
| Example 1 | 11.1 | 0.46 |
| Example 2 | 12.1 | 0.49 |
| Example 3 | 12.7 | 0.45 |
| Comparative | 11.6 | 0.46 |
| Example 1 | | |
| Example 4 | 14.5 | 0.80 |
| Example 5 | 14.5 | 0.53 |
| Example 6 | 14.1 | 0.61 |
| Comparative | 14.1 | 0.60 |
| Example 2 | | |
| Example 7 | 13.7 | 0.65 |
| Example 8 | 13.9 | 0.64 |
| Example 9 | 13.3 | 1.13 |
| Comparative | 13.6 | 1.24 |
| Example 3 | | |

### EXAMPLES

Example 1: Example 1 is prepared by addition of 2.5 g (0.25 phr) of MDI-MB (MB: masterbatch; wherein, concentration of MDI-Ani was maintained at 10 wt. %) in 1000 g of iPP; wherein in the prepared nucleated polypropylene concentration of nucleating agent would be 250 ppm.

Example 2: Example 2 is prepared by addition of 5 g (0.50 phr) of MDI-MB in 1000 g of iPP; wherein in the prepared nucleated polypropylene concentration of nucleating agent would be 500 ppm.

Example 3: Example 3 is prepared by addition of 10 g (1.00 phr) of MDI-MB in 1000 g of iPP; wherein in the prepared nucleated polypropylene concentration of nucleating agent would be 1000 ppm.

Comparative Example 1: Comparative Example 1 is prepared by direct addition of 1.0 g (1000 ppm) of MDI-Ani in 1000 g of iPP.

Example 4: Example 4 is prepared by addition of 2.5 g (0.25 phr) of IPDI-MB (MB: masterbatch; wherein, concentration of IPDI-Ani was maintained at 10 wt. %) in 1000 g of iPP; wherein in the prepared nucleated polypropylene concentration of nucleating agent would be 250 ppm.

Example 5: Example 5 is prepared by addition of 5 g (0.50 phr) of IPDI-MB in 1000 g of iPP; wherein in the prepared nucleated polypropylene concentration of nucleating agent would be 500 ppm.

Example 6: Example 6 is prepared by addition of 10 g (1.00 phr) of IPDI-MB in 1000 g of iPP; wherein in the prepared nucleated polypropylene concentration of nucleating agent would be 1000 ppm.

Comparative Example 2: Comparative Example 2 is prepared by direct addition of 1.0 g (1000 ppm) of IPDI-Ani in 1000 g of iPP.

Example 7: Example 7 is prepared by addition of 2.5 g (0.25 phr) of HMDI-MB (MB: masterbatch; wherein, concentration of HMDI-Ani was maintained at 10 wt. %) in 1000 g of iPP; wherein in the prepared nucleated polypropylene concentration of nucleating agent would be 250 ppm.

Example 8: Example 8 is prepared by addition of 5 g (0.50 phr) of HMDI-MB in 1000 g of iPP; wherein in the prepared nucleated polypropylene concentration of nucleating agent would be 500 ppm.

Example 9: Example 9 is prepared by addition of 10 g (1.00 phr) of HMDI-MB in 1000 g of iPP; wherein in the prepared nucleated polypropylene concentration of nucleating agent would be 1000 ppm.

Comparative Example 3: Comparative Example 3 is prepared by direct addition of 1.0 g (1000 ppm) of HMDI-Ani in 1000 g of iPP.

We claim:

1. A process for preparing a nucleating agent masterbatch by melt mixing a polypropylene having a melt flow index ranging in between 1.5 to 40 g/10 min with a nucleating agent having wt. % in a range of 2 to 60 wt. %; wherein the nucleating agent is a reaction product of at least one isocyanate and at least one amine, and wherein the wt. % is based on the total weight of the masterbatch.

2. The process as claimed in claim 1, wherein the isocyanate is selected from a group consisting of aliphatic, cycloaliphatic, aryl aliphatic, and aromatic isocyanates.

3. The process as claimed in claim 2, wherein the isocyanate is a diisocyanate such as Methylene diphenyl diisocyanate (MDI), Isophorone diisocyanate (IPDI), and Hexamethylene diisocyanate (HMDI).

4. The process as claimed in claim 1, wherein the amine is an aromatic amine and the aromatic amine is selected from a group comprising of aniline, p-aminotoluene, o-aminotoluene, 2,4-diaminotoluene, 2,6-diaminotoluene, p-phenylaniline, α-aminonaphthylene, 4,4′-diaminobiphenyl, p-phenylenediamine, and 4,4′-methylenebisaniline.

5. The process as claimed in claim 4, wherein the aromatic amine is aniline.

6. The process as claimed in claim 1, wherein the amine is an aliphatic amine, and the aliphatic amine is selected from a group comprising of methyl amine and ethyl amine.

7. The process as claimed in claim 1, wherein the amine is a cycloaliphatic amine, and the cycloaliphatic amine is hexyl amine.

8. The process as claimed in claim 1, wherein the melt mixing is carried out at a temperature ranging between 150-300° C.

9. The process as claimed in claim 1, wherein the polypropylene is polypropylene homopolymer, and/or polypropylene copolymer with any other alkene or acrylate or halo-alkenes.

10. The process as claimed in claim 1, wherein the concentration of nucleating agents further diluted to 250-20000 ppm in polypropylene to make nucleated polypropylene.

11. The process claimed in claim 1, wherein the melt mixing for preparing the master batch with polypropylene and nucleating agent is carried out in batch mixer, micro-compounder, single screw extruder, two roll mill or any other processing equipment.

12. The process as claimed in claim 10, wherein crystallization temperature is increased from 116° C. to 129° C. by incorporation of 250 to 1000 ppm.

13. A nucleated polypropylene having the nucleating agent masterbatch obtained by the process as claimed in claims 1.

14. A process for preparing a nucleated polypropylene by melt mixing the polypropylene having a melt flow index ranging in between 1.5 g/10 min to 40 g/10 min with the nucleating agent masterbatch obtained by the process as claimed in claims 1.
